(19) United States
(12) Patent Application Publication
(10) Pub. No.: US 2018/0026372 A1
(43) Pub. Date: Jan. 25, 2018

(54) ANTENNA WITH MULTIPLE RESONANT COUPLING LOOPS

(71) Applicant: Microsoft Technology Licensing, LLC, Redmond, WA (US)

(72) Inventor: Marc Harper, Seattle, WA (US)

(21) Appl. No.: 15/217,020

(22) Filed: Jul. 22, 2016

(51) Int. Cl. H01Q 7/00; H01Q 1/48; H01Q 1/24

(52) U.S. Cl. CPC H01Q 7/00; H01Q 1/243; H01Q 1/48

(57) ABSTRACT

An antenna arrangement with an active radiating element forming a plurality of inductively-coupled resonating loop antennas drives a parasitic radiating element. The active radiating element is electrically coupled to a feed contact and tuned according to one or more variable capacitors and inductors. The active radiating element drives the parasitic radiating element into a state of resonance for transmitting and receiving wireless communication radiofrequency waves. The antenna arrangement provides a relatively stable return loss profile over a wide frequency band, which may be adjusted to fit a desired communications band.

### BACKGROUND

Small, tuned loop antennas may offer good performance but can be confined to a frequency band that is narrower than desired. Small, tuned loop antennas may also have an inconsistent return loss response over the frequency band, wherein at certain frequencies, the return loss may differ considerably as compared to the rest of the frequency band.

### SUMMARY

Multiple active resonant inductively-coupled loop antennas in a small, tuned antenna will allow for a substantial increase in bandwidth while maintaining a consistent return loss response across the frequency band. An antenna arrangement includes a parasitic resonating element, wherein the parasitic resonating element is configured to be fed parasitically by a plurality of active inductively-coupled resonating loops. The plurality of active inductively-coupled resonating loops may be tuned with variable capacitors and/or inductors, to provide consistent performance over a wide frequency range.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example computing device with a parasitic antenna driven by multiple inductively-coupled resonating loops.

FIG. 2 illustrates an example antenna arrangement with a parasitic resonating element excited by an active resonating element with multiple inductively-coupled resonating loops.

FIG. 3 illustrates example current loops in an antenna arrangement with a parasitic resonating element excited by an active resonating element with multiple inductively-coupled resonating loops.

FIG. 4 is a plot of the return loss of a parasitic antenna driven by multiple active inductively-coupled resonating loops against frequency.

FIG. 5 is a circuit diagram illustrating an equivalent circuit of a parasitic antenna driven by multiple inductively-coupled resonating loops.

FIG. 6 illustrates example operations for resonating a parasitic antenna driven by multiple inductively-coupled resonating loops.

FIG. 7 is a Smith chart plot for an example parasitic antenna driven by multiple active inductively-coupled resonating loops.

FIG. 8 illustrates an example system that may be useful in implementing the described technology.

### DETAILED DESCRIPTIONS

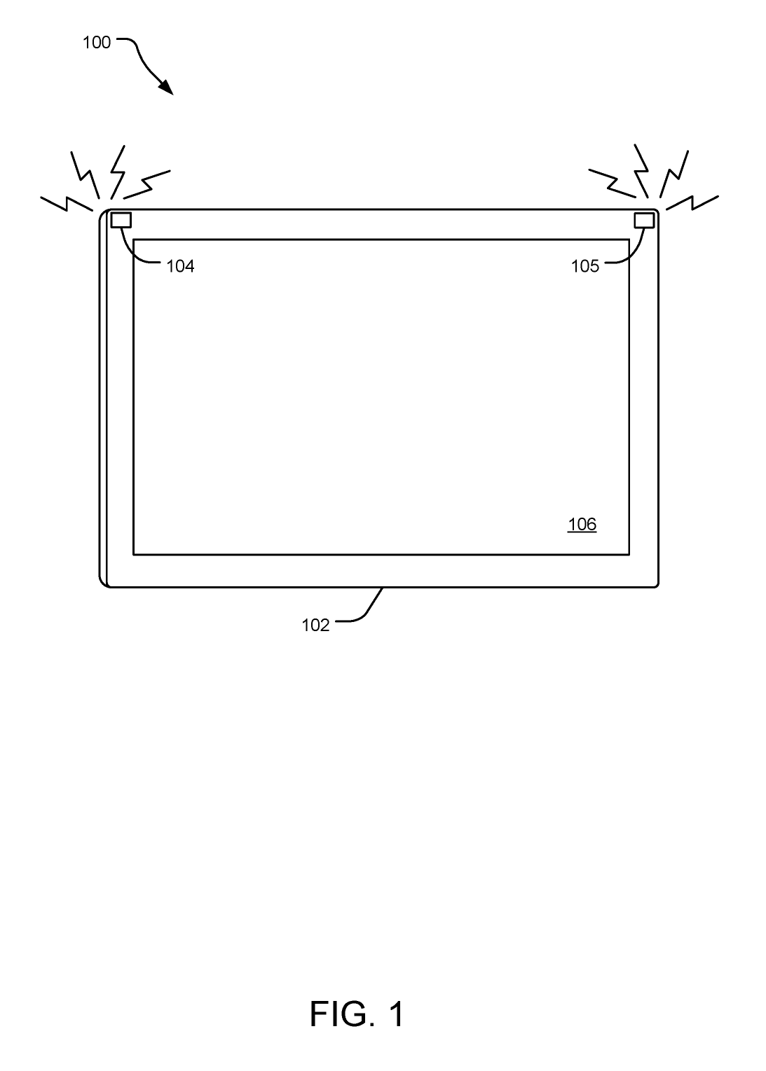

FIG. 1 depicts an illustrative electronic device 100 having an antenna including an active resonating element forming a plurality of inductively-coupled loop antennas driving a parasitic resonating element. In an implementation, the parasitic resonating element may be a magnetic dipole antenna and the active resonating element includes multiple inductively-coupled resonating loop antennas. The electronic device 100 may be any type of electronic device including without limitation hand-held, portable electronic devices, such as phones, tablets, and gaming devices, as well as desktop devices, virtual reality devices, and wearable devices such as jewelry, watches, glasses, etc. The electronic device 100 may be housed in a device case 102, which may be a metal device case, a plastic device case, etc., or any combination thereof. The electronic device 100 may include a display 106, one or more processors, a memory, input/output circuits, and other components useful in the implementations described herein.

The electronic device 100 includes one or more antennas 104 and 105 for sending and receiving wireless communications. The antennas 104 and 105 may be configured to send and receive communications over one or more communication bands or configured to send and receive communications over the same communication band. For example, in the electronic device 100, the first antenna 104 may be tuned to cellular telephone communications and the second antenna 105 may be tuned to a separate communications band to handle data communications. The antennas 104 and 105 may be placed at alternative locations on the electronic device 100 than the locations shown in FIG. 1.

The antennas 104 and 105 include a parasitic resonating element driven by an active resonating element. The active resonating element may be coupled to a feed contact, which may communicate a radiofrequency wave from a transceiver to the active resonating element. The active resonating element may be formed by a plurality of inductively-coupled loops and may be tuned to impedance match a desired impedance according to one or more variable capacitors and one or more variable inductors, such as electronically-adjustable capacitors and/or inductors. The parasitic resonating element may include a variable capacitive element, such as a chip antenna having an electronically-adjustable capacitance. The inductively-coupled loops operate to create current loops that capacitively couple with the parasitic resonating elements of each antenna 104 and 105 to excite the parasitic resonating elements of the antennas 104 and 105.

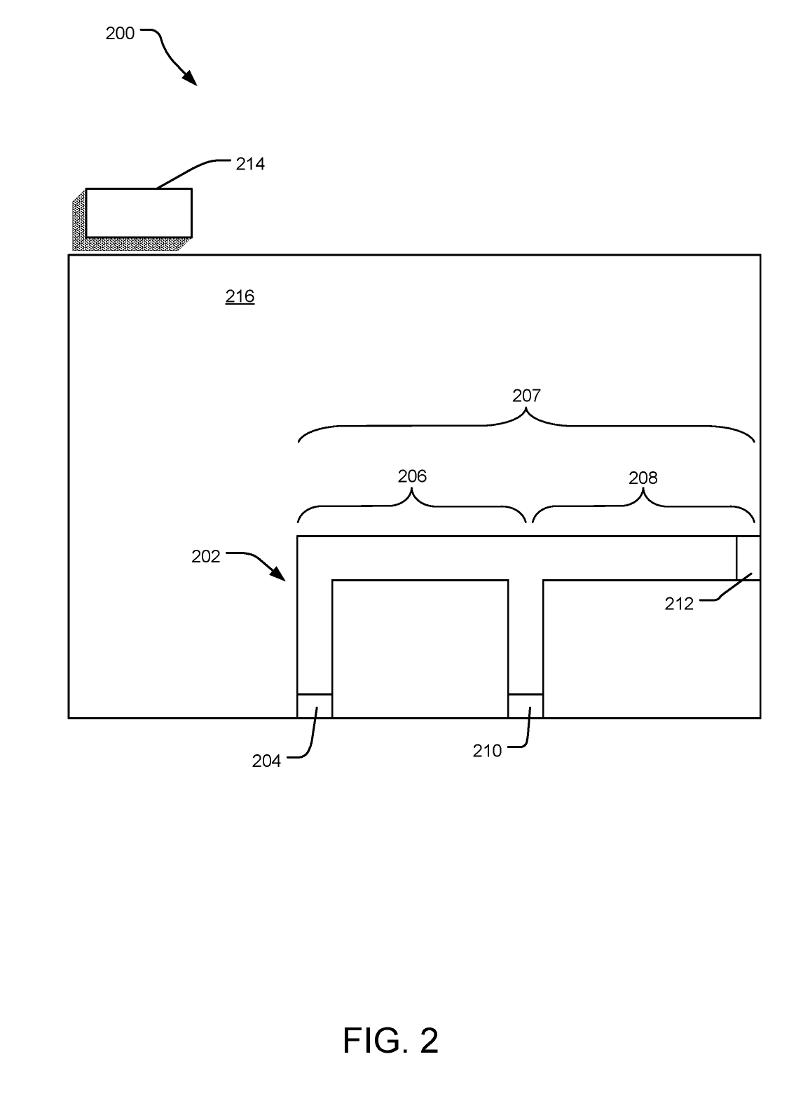

FIG. 2 illustrates an antenna arrangement 200 with a parasitic resonating element 214 excited by an active resonating element 202 with multiple inductively-coupled resonating loops 206 and 208. In an implementation the parasitic resonating element 214 may be capacitively driven by the active resonating element 202. The antenna arrangement 200 may be formed from electrically conductive track(s) formed on a PCB substrate 216. In an implementation, the PCB substrate 216 has dimensions of 4 mm×8 mm. In other implementations, the PCB substrate 216 has a larger or smaller area or is in a shape that is not a rectangle. In another implementation, the PCB substrate may be a dielectric substrate. Additionally, or alternatively, the PCB substrate may be disposed above a ground plane. The active resonating element 202 includes a feed contact 204 for driving the active resonating element 202. In an implementation, the feed contact 204 supplies a radiofrequency signal source to the active resonating element 202. In another implementation, the feed contact 204 is communicatively coupled to a radio transceiver configured to transmit a radio frequency carrier wave to the active resonating element 202. In an implementation, the parasitic resonating element 214 is disposed on the opposite side of the PCB substrate 216 from the active resonating element 202. In another implementation, the parasitic resonating element 214 is not disposed on the dielectric substrate.

The active resonating element 202 may be routed across the surface of a dielectric substrate and be arranged into inductively-coupled loops 206 and 208. When the feed contact 204 drives the active resonating element 202, current loops form in the inductively-coupled loops 206 and 208. Inductive coupling, also called magnetic field coupling, occurs when energy is coupled from one circuit to another through a magnetic field. Since currents are sources of magnetic fields, inductive coupling is most likely to happen when the impedance of the source circuit is low. Another current loop 207 encompassing both inductively-coupled loops 206 and 208 also forms. The current loops associated with inductively-coupled loops 206 and 208 may couple with each other and with a current loop including the parasitic resonating element 214 to excite the parasitic resonating element 214 into a state of resonance. Exciting the parasitic resonating element 214 in this manner is possible over a wide range of frequencies without substantial loss of return loss response. As such, the inductively-coupled loops 206 and 208 driving the parasitic resonating element 214 may produce an acceptably smooth and constant return loss response over a wide frequency range for many applications relating to electronic device communications. In an implementation, a return loss of around −6 dB may result over a frequency range of approximately 2.0 GHz to 2.9 GHz. One characteristic of the return loss response over this frequency range is that, although the return loss response may not be constant, the return loss response over the frequency range does not exhibit sharp dips or rises at any subsets of the frequency range. In an implementation, the active resonating element 202 is arranged into more than two inductively-coupled loops, for example without limitation three or more inductively coupled loops. In an implementation, the active resonating element may be electrically connected to ground, including without limitation via a ground plane.

In an implementation, the active resonating element 202 includes components to impedance match to a desired impedance, such as to match the impedance of the feed contact 204 (e.g., 50 Ohms). For example, a capacitor 210 can be disposed on the opposite end of the inductively-coupled loop 206 from the feed contact 204, and an inductor 212 can be disposed at the end of the inductively-coupled loop 208. The values of the capacitor 210 and the inductor 212 may be selected depending on the dimensions of the inductively-coupled loops 206, 207, and 208 to match the impedance of the feed contact 204 or any other desired impedance. In another implementation, the capacitor 210 is a variable capacitor. The inductor 212 may also be a variable inductor. In an implementation, the inductor 212 includes a multi-switch configured to select among a variety of inductors with varying inductance values, such that a selected inductor with a desired inductance value may be electrically connected to the active resonating element 202.

The antenna arrangement 200 also includes a parasitic resonating element 214. The parasitic resonating element 214 may be sized and positioned to resonate at a target frequency. When the feed contact 204 drives the active resonating element 202, the active resonating element 202 emits a radiofrequency wave oscillating at the target frequency. The radiofrequency wave emitted by the active resonating element 202 excites the parasitic resonating element 214 into a state of resonance. When excited into a state of resonance by the active resonating element 214, the parasitic resonating element 214 effectively re-transmits the radiofrequency wave at a higher transmission power. Consequently, the transmitted radiofrequency wave is detectable by a receiving antenna on another electronic device or by an antenna that is part of a wireless communications infrastructure.

The parasitic resonating element 214 may be implemented in a variety of shapes and sizes depending on both electrical and mechanical funcationality and/or asthetic design criteria. The parasitic resonating element 214 may be formed from a conductive track and may be grounded at one or both ends. The parasitic resonating element 214 may take a variety of forms including without limitation a solid, planar component, a chip antenna, an LTE antenna, a variable capacitor antenna, a non-grounded (i.e., “floating” structure), a Global Positioning System (GPS) antenna, a metalized block slot antenna, etc. In an implementation including a chip antenna as the parasitic resonating element, the chip antenna may be a surface mount device formed from a dielectric material with high permittivity and low loss properties such as a ceramic. The chip antenna may be tuned to transmit and/or receive on a desired frequency with a variable capacitor. In another implementation, a current in the chip antenna may alter the dielectric properties of the dielectric material to adjust the frequency on which the chip antenna transmits and receives.

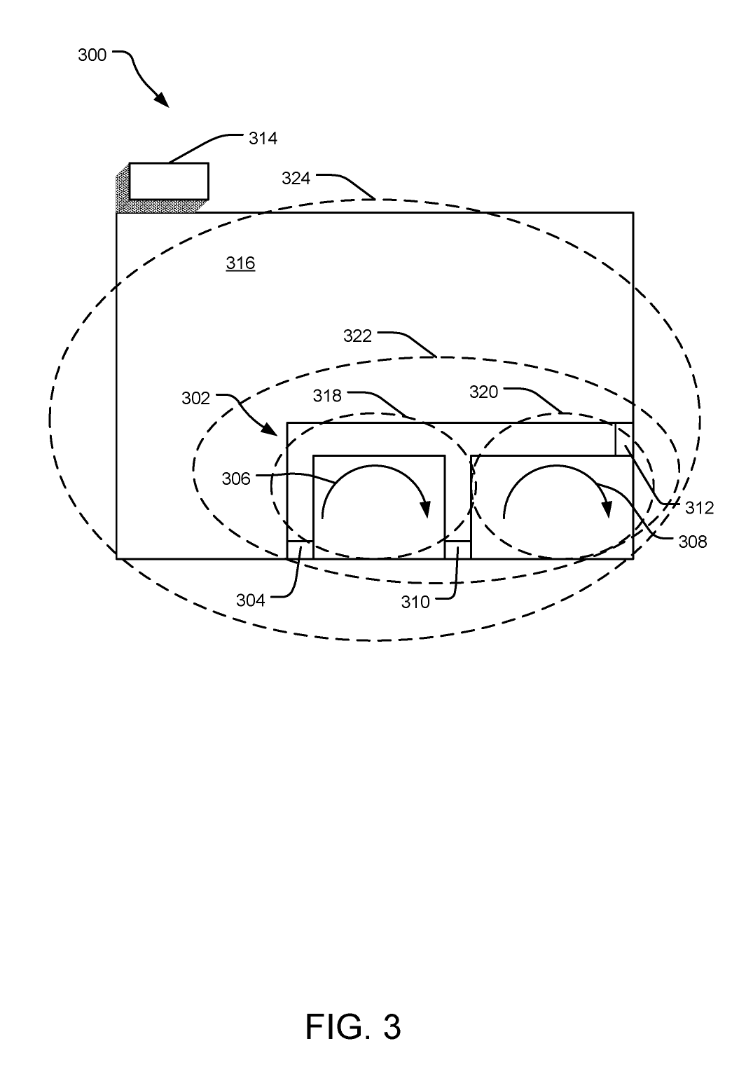

FIG. 3 illustrates example current loops 318, 320, 322, and 324 in an antenna arrangement 300 with a parasitic resonating element 314 excited by an active resonating element 302 with multiple inductively-coupled resonating loops. In an implementation the parasitic resonating element 314 may be capacitively driven by the active resonating element 302. The antenna arrangement 300 may be formed from electrically conductive track(s) formed on a PCB substrate 316. In an implementation, the PCB substrate 316 has dimensions of 4 mm×8 mm. In other implementations, the PCB substrate 316 has a larger or smaller area or is in a shape that is not a rectangle. In another implementation, the PCB substrate may be a dielectric substrate. Additionally, or alternatively, the PCB substrate may be disposed above a ground plane. The active resonating element 302 includes a feed contact 304 for driving the active resonating element 302. In an implementation, the feed contact 304 supplies a radiofrequency signal source to the active resonating element 302. In another implementation, the feed contact 304 is communicatively coupled to a radio transceiver configured to transmit a radio frequency carrier wave to the active resonating element 302. In an implementation, the parasitic resonating element 314 is disposed on the opposite side of the dielectric substrate from the active resonating element 302. In another implementation, the parasitic resonating element 314 is not disposed on the dielectric substrate.

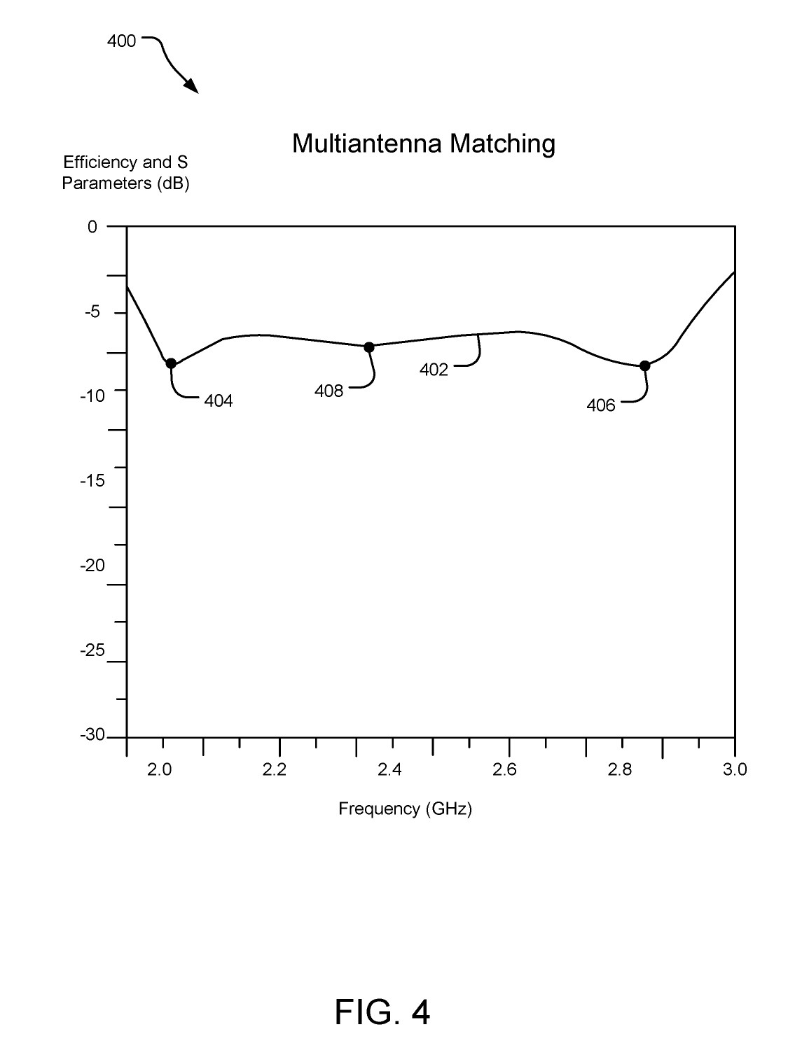

The active resonating element 302 may be routed across the surface of a dielectric substrate and be arranged into inductively-coupled loops. When the feed contact 304 drives the active resonating element 302, current loops form within the inductively-coupled loops in the direction of arrows 306, 308. The current loops 318, 320 associated with the inductively-coupled loops may couple with each other to form current loop 322. The current loops 318, 320 associated with the inductively-coupled loops may also form with a current loop 324 including the parasitic resonating element 314 to excite the parasitic resonating element 314 into a state of resonance. Exciting the parasitic resonating element 314 in this manner is possible over a wide range of frequencies without substantial loss of bandwidth response. In other words, the inductively-coupled loops driving the parasitic resonating element 314 may produce an acceptably smooth and constant bandwidth response over a wide range of frequencies for many applications relating to electronic device communications. In an implementation, a bandwidth of around −6 dB may result over a frequency range of approximately 2.0 GHz to 2.9 GHz, as shown in more detail with reference to FIG. 4. One characteristic of the bandwidth response over this frequency range is that, although the bandwidth response may not be constant, the bandwidth response over the frequency range does not exhibit sharp dips at any subsets of the frequency range. In an implementation, the active resonating element 302 is arranged into more than two inductively-coupled loops, for example without limitation three or more inductively coupled loops. In an implementation, the active resonating element may be electrically connected to ground, including without limitation via a ground plane.

The active resonating element 302 may include components to impedance match to a desired impedance, such as to match the impedance of the feed contact 304. In an implementation, a capacitor 310 is disposed on the opposite end of the inductively-coupled loop 306 from the feed contact 304, and an inductor 312 is disposed at the end of the inductively-coupled loop 308. The values of the capacitor 310 and the inductor 312 may be selected depending on the dimensions of the inductively-coupled loops 306, 308 to match the impedance of the feed contact 304 or any other desired impedance. In another implementation, the capacitor 310 is a variable capacitor whose reactance may be adjusted mechanically or electrically. The inductor 312 may also be a variable inductor whose inductance may be adjusted. In an implementation, the inductor 312 includes a multi-switch configured to select among a variety of inductors with varying inductance values, such that a selected inductor with a desired inductance value may be electrically connected to the active resonating element 302.

The antenna arrangement 300 also includes a parasitic resonating element 314. The parasitic resonating element 314 may be sized and positioned to resonate at a target frequency. When the feed contact 304 drives the active resonating element 302, the active resonating element 302 emits a radiofrequency wave oscillating at the target frequency. The radiofrequency wave emitted by the active resonating element 302 excites the parasitic resonating element 314 into a state of resonance. When excited into a state of resonance by the active resonating element 314, the parasitic resonating element 314 effectively re-transmits the radiofrequency wave at a higher transmission power. Consequently, the transmitted radiofrequency wave is detectable by a receiving antenna on another electronic device or by an antenna that is part of a wireless communications infrastructure.

In an implementation, the active resonating element 302 may radiate at substantially the same frequency or in the same frequency band as the parasitic resonating element 314, in which case it acts as a simple feed. In another implementation, the active resonating element 302 may alternatively, or additionally, radiate at a different frequency or in a different frequency band as the parasitic raditating element 314, the frequency or frequency band being selected so as to provide an additional resonance for multi-band operation while still coupling with the parasitic resonating elements so as to cause these to resonate parasitically. In yet another implementation, a first parasitic resonating element may radiate at the same frequency or in the same frequency band as the active resonating element 302, and a second parasitic resonating element may resonate at a different frequency or in a different frequency band. The parasitic resonating element may radiate at a frequency in the Bluetooth™ and/or Wi-Fi frequency bands, but operation in other frequency bands is also contemplated. For example, the second parasitic resonating element may be a conductive track tuned to resonate in the Global Positioning System (GPS) band to provide communications in the GPS frequency band in addition to communication in the frequency band served by the parasitic resonating element 314.

The parasitic resonating element 314 may be implemented in a variety of shapes and sizes depending on both electrical and mechanical funcationality and/or asthetic design criteria. The parasitic resonating element 314 may be formed from a conductive track and may be grounded at one or both ends. The parasitic resonating element 314 may take a variety of forms including without limitation a solid, planar component, a chip antenna, an LTE antenna, a variable capacitor antenna, a non-grounded (i.e., “floating” structure), a Global Positioning System (GPS) antenna, a metalized block slot antenna, etc.

FIG. 4 is a plot 400 of the return loss of a parasitic resonating element driven by multiple active inductively-coupled resonating loops against frequency. The horizontal axis represents the parasitic resonating element's center frequency in gigahertz, and the vertical axis represents return loss magnitude in decibels of the parasitic resonating element. A curve 402 represents the return loss of a parasitic antenna driven by multiple active inductively-coupled resonating loops for the frequencies represented on the horizontal axis. The curve 402 is approximately constant over the bandwidth range shown in FIG. 4 due to the combination of the multiple current loops in the inductively-coupled resonating loops. An antenna arrangement with a single active resonating loop may experience a more efficient return loss at a frequency corresponding to the impedance of the single active resonating loop but with poorer return loss in other parts of the frequency range. In another example, an antenna arrangement with multiple active resonating loops may experience multiple frequency points with more efficient return loss at various frequencies corresponding to the impedances of each of the resonating loops but with poorer return loss in between those points.

The curve 402 illustrates smooth, relatively constant return loss due to multiple inductively-coupled resonating loops. In an arrangement including multiple inductively-coupled loops, the antenna remains well matched across a frequency range measuring approximately 900 MHz, and therefore provides good performance across the entire frequency band shown in FIG. 4. The curve 402 includes a point 404 at a frequency associated with a return loss corresponding to a first inductively-coupled resonating loop, a point 406 associated with a return loss corresponding to a second inductively-coupled resonating loop, and a point 408 associated with a return loss corresponding to a current loop encompassing more than one inductively-coupled loop. The location of points 404, 406, and 408 may be adjusted by tuning the inductively-coupled resonating loop corresponding to each point and/or varying the dimensions of each inductively-coupled resonating loop. In an implementation, the frequency band shown in FIG. 4 measuring approximately 900 MHz across may be adjusted to higher or lower frequencies by tuning the inductively-couled resonating loops to move the points 404, 406, 408 in the desired frequency direction while maintaining the overall shape of the curve 402.

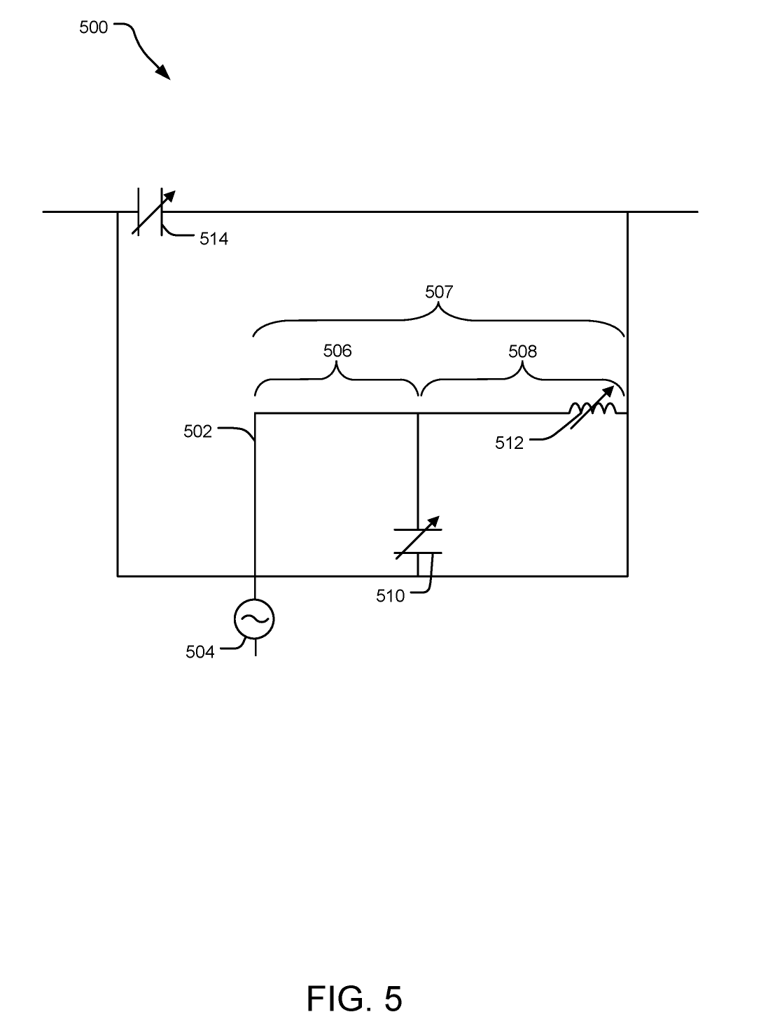

FIG. 5 is a circuit diagram 500 illustrating an equivalent circuit of an antenna arrangement with a parasitic resonating element 514 excited by an active resonating element 502 with multiple inductively-coupled resonating loops 506 and 508. In an implementation the parasitic resonating element 514 may be capacitively driven by the active resonating element 502. The antenna arrangement 500 may be formed from electrically conductive track(s) formed on a PCB substrate. In an implementation, the PCB substrate has dimensions of 4 mm×8 mm. In other implementations, the PCB substrate has a larger or smaller area or is in a shape that is not a rectangle. In another implementation, the PCB substrate may be a dielectric substrate. Additionally, or alternatively, the PCB substrate may be disposed above a ground plane. The active resonating element 502 includes a transceiver 504 for driving the active resonating element 502. In an implementation, the transceiver 504 supplies a radiofrequency signal source to the active resonating element 502. In an implementation, the parasitic resonating element 514 is disposed on the opposite side of the dielectric substrate from the active resonating element 502. In another implementation, the parasitic resonating element 514 is not disposed on the dielectric substrate.

The active resonating element 502 may be routed across the surface of a dielectric substrate and be arranged into inductively-coupled loops 506 and 508. When the transceiver 504 drives the active resonating element 502, current loops form in the inductively-coupled loops 506 and 508. Another current loop 507 encompassing both inductively-coupled loops 506 and 508 also forms. The current loops associated with inductively-coupled loops 506, 507, and 508 may couple with each other and with a current loop including the parasitic resonating element 514 to excite the parasitic resonating element 514 into a state of resonance. Exciting the parasitic resonating element 514 in this manner is possible over a wide range of frequencies without substantial loss of bandwidth response. As such, the inductively-coupled loops 506, 507, and 508 driving the parasitic resonating element 514 may produce an acceptably smooth and constant bandwidth response over a wide range of frequencies for many applications relating to electronic device communications. In an implementation, a bandwidth of around −6 dB may result over a frequency range of approximately 2.0 GHz to 2.9 GHz. One characteristic of the bandwidth response over this frequency range is that, although the bandwidth response may not be constant, the bandwidth response over the frequency range does not exhibit sharp dips or rises at any subsets of the frequency range. In an implementation, the active resonating element may be electrically connected to ground, including without limitation via a ground plane.

In an implementation, the active resonating element 502 is arranged into more than two inductively-coupled loops, for example without limitation three or more inductively coupled loops. In an implementation, the active resonating element 502 includes components to impedance match to a desired impedance, such as to match the impedance of the transceiver 504 (e.g., 50 Ohms). For example, a capacitor 510 can be disposed on the opposite end of the inductively-coupled loop 506 from the transceiver 504, and an inductor 512 can be disposed at the end of the inductively-coupled loop 508. The values of the capacitor 510 and the inductor 512 may be selected depending on the dimensions of the inductively-coupled loops 506, 507, and 508 to match the impedance of the transceiver 504 or any other desired impedance. In an implementation, the inductor 512 has a value of 1.5 nanohenries and the capacitor 510 has a value of 0.9 picofarads. In another implementation, the capacitor 510 is a variable capacitor. The inductor 512 may also be a variable inductor. In an implementation, the inductor 512 includes a multi-switch configured to select among a variety of inductors with varying inductance values, such that a selected inductor with a desired inductance value may be electrically connected to the active resonating element 502.

The antenna arrangement 500 also includes a parasitic resonating element 514. The parasitic resonating element 514 may be sized and positioned to resonate at a target frequency. When the transceiver 504 drives the active resonating element 502, the active resonating element 502 emits a radiofrequency wave oscillating at the target frequency. The radiofrequency wave emitted by the active resonating element 502 excites the parasitic resonating element 514 into a state of resonance. When excited into a state of resonance by the active resonating element 514, the parasitic resonating element 514 effectively re-transmits the radiofrequency wave at a higher transmission power. Consequently, the transmitted radiofrequency wave is detectable by a receiving antenna on another electronic device or by an antenna that is part of a wireless communications infrastructure.

The parasitic resonating element 514 may be implemented in a variety of shapes and sizes depending on both electrical and mechanical funcationality and/or asthetic design criteria. The parasitic resonating element 514 may be formed from a conductive track and may be grounded at one or both ends. The parasitic resonating element 514 may take a variety of forms including without limitation a solid, planar component, a chip antenna, an LTE antenna, a variable capacitor antenna, a non-grounded (i.e., “floating” structure), a Global Positioning System (GPS) antenna, a metalized block slot antenna, etc.

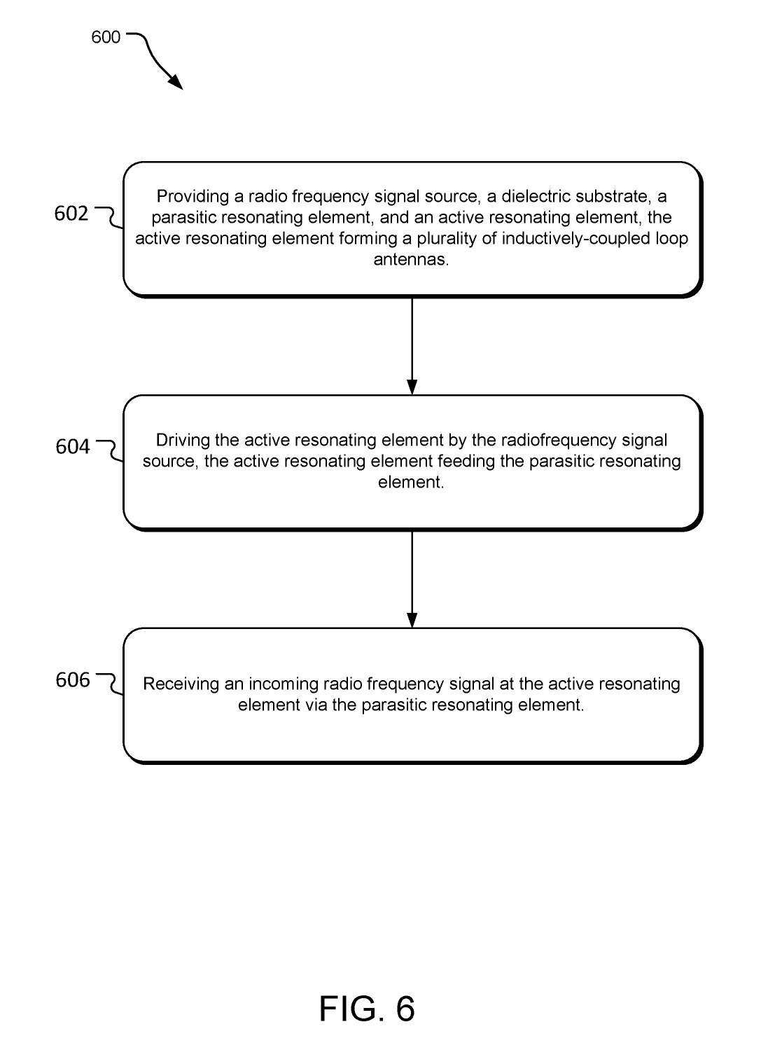

FIG. 6 illustrates example operations 600 for resonating a parasitic antenna driven by multiple inductively-coupled resonating loops. The multiple inductively-coupled resonating loops are part of an active resonating element, and are excited by a feed contact into a state of resonance. The active resonating element is impedance matched according to one or more variable capacitors and inductors in electrical communication with the active resonating element. A providing operation 602 provides a radio frequency signal source, a dielectric substrate, a parasitic resonating element, and an active resonating element, the active resonating element forming a plurality of inductively-coupled loop antennas. The active resonating element may be disposed on the dielectric substrate and positioned to excite the parasitic resonating element into a state of resonance when driven by the radiofrequency signal source. In an implementation, the radiofrequency signal source is a transceiver configured to transmit a radiofrequency wave to, or receive a radiofrequency wave from, the active resonating element. In an implementation, the parasitic resonating element is disposed outside of the dielectric substrate, including without limitation, on a interior or exterior part of an electrical device case. In another implementation, the parasitic resonating element is disposed on the dielectric substrate.

A driving operation 604 drives the active resonating element by the radiofrequency signal source, the active resonating element feeding the parasitic resonating element by exciting the parasitic resonating element into a state of resonance. In an implementation, the active resonating element may radiate at substantially the same frequency or in the same frequency band as the parasitic resonating element, in which case it acts as a simple feed. In another implementation, the active resonating element may alternatively, or additionally, radiate at a different frequency or in a different frequency band as the parasitic raditating element, the frequency or frequency band being selected so as to provide an additional resonance for multi-band operation while still coupling with the parasitic resonating elements so as to cause these to resonate parasitically. A receiving operation 606 receives an incoming radiofrequency signal at the active resonating element via the parasitic resonating element. In an implementation, the incoming radiofrequency signal may be received by a transceiver electrically coupled to the active resonating element. The transceiver may communicate the received radiofrequency signal to an associated electronic device.

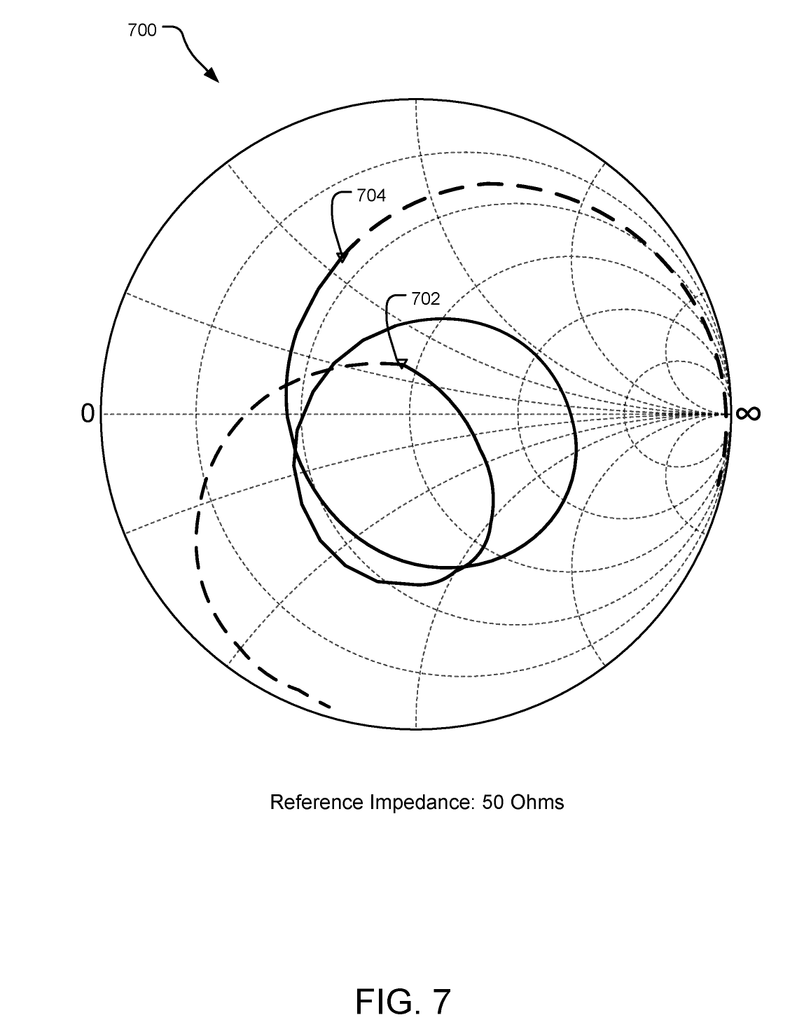

FIG. 7 is a Smith chart plot 700 for an example parasitic antenna driven by multiple active inductively-coupled resonating loops. A good match to 50 Ohms was obtained at 2.0 GHz and 2.9 GHz, shown at points 702 and 704, respectively. In other parasitic antenna configurations, good matches to 50 Ohms may be found by adjusting the inductance and capacitance values of the parasitic antenna. Examples of other parasitic antenna configurations include without limitation, changing the relative length and size of the inductively-coupled loops, changing the number of inductively-coupled loops, changing the orientation and location of the parasitic resonating element.

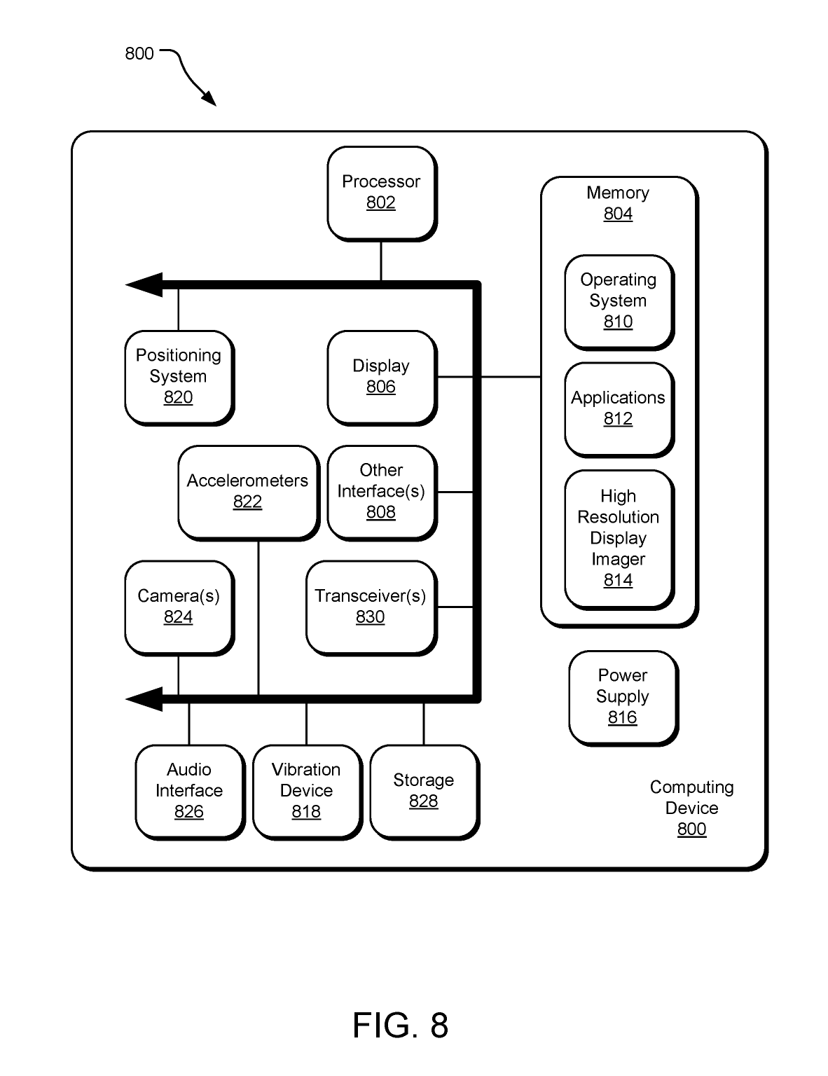

FIG. 8 illustrates an example system labeled as computing device 800 that may be useful in implementing the described technology. The example hardware and operating environment of FIG. 8 for implementing the described technology includes a computing device, such as a general purpose computing device in the form of a computer, a mobile telephone, a personal data assistant (PDA), a tablet, smart watch, gaming remote, or other type of computing device. It should be appreciated by those skilled in the art that any type of tangible computer-readable media may be used in the example operating environment. The computer may operate in a networked environment using logical connections to one or more remote computers, such as a remote computer. These logical connections are achieved by a communication device coupled to or a part of the computer; the implementations are not limited to a particular type of communications device. The remote computer may be another computer, a server, a router, a network PC, a client, a peer device or other common network node, and typically includes many or all of the elements described above relative to the computer.

The computing device 800 includes a processor 802, a memory 804, a display 806 (e.g., a touchscreen display), and other interfaces 808 (e.g., a keyboard). The memory 804 generally includes both volatile memory (e.g., RAM) and non-volatile memory (e.g., flash memory). An operating system 810, such as the Microsoft Windows® Mobile operating system, resides in the memory 804 and is executed by the processor 802, although it should be understood that other operating systems may be employed.

One or more application programs 812, such as a high resolution display imager 814, are loaded in the memory 804 and executed on the operating system 808 by the processor 802. The computing device 800 includes a power supply 816, which is powered by one or more batteries or other power sources and which provides power to other components of the computing device 800. The power supply 816 may also be connected to an external power source that overrides or recharges the built-in batteries or other power sources.

The computing device 800 includes one or more communication transceivers 830 to provide network connectivity (e.g., mobile phone network, Wi-Fi®, BlueTooth®, etc.). The computing device 800 also includes various other components, such as a positioning system 820 (e.g., a global positioning satellite transceiver), one or more accelerometers 822, one or more cameras 824, an audio interface 826 (e.g., a microphone, an audio amplifier and speaker and/or audio jack), a magnetometer (not shown), and additional storage 828. Other configurations may also be employed. The one or more communications transceivers 830 may be communicatively coupled to one or more antennas, including magnetic dipole antennas capacitively coupled to a parasitic resonating element. The one or more transceivers 830 may further be in communication with the operating system 810, such that data transmitted to or received from the operating system 810 may be sent or received by the communications transceivers 830 over the one or more antennas.

In an example implementation, a mobile operating system, wireless device drivers, various applications, and other modules and services may be embodied by instructions stored in memory 804 and/or storage devices 828 and processed by the processing unit 802. Device settings, service options, and other data may be stored in memory 804 and/or storage devices 828 as persistent datastores. In another example implementation, software or firmware instructions for generating carrier wave signals may be stored on the memory 804 and processed by processor 802. For example, the memory 804 may store instructions for tuning multiple inductively-coupled loops to impedance match a desired impedance at a desired frequency.

Mobile device 800 may include a variety of tangible computer-readable storage media and intangible computer-readable communication signals. Tangible computer-readable storage can be embodied by any available media that can be accessed by the computing device 800 and includes both volatile and nonvolatile storage media, removable and non-removable storage media. Tangible computer-readable storage media excludes intangible communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by computing device 800 or computer 20. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

An example device includes a radiofrequency signal source, a dielectric substrate, an active resonating element routed across the surface of the dielectric substrate and driven by the radiofrequency signal source where the active resonating element forming a plurality of inductively-coupled loop antennas. And a parasitic resonating element is capacitively driven by the inductively-coupled loop antennas.

Another example device of any preceeding device includes the parasitic resonating element is a chip antenna.

Another example device of any preceeding device includes the parasitic resonating element is a variable capacitor.

Another example device of any preceeding device includes the parasitic resonating element is an LTE antenna.

Another example device of any preceeding device includes the active resonating element forms two loop antennas.

Another example device of any preceeding device includes the active resonating element and the parasitic resonating element are arranged on opposite sides of the substrate.

Another example device of any preceeding device includes the active resonating element includes at least one capacitor and at least one inductor.

An example method includes providing a radiofrequency signal source, a dielectric substrate, a parasitic resonating element, and an active resonating element, the active resonating element forming a plurality of inductively-coupled resonating loop antennas, and driving the active resonating element by the radiofrequency signal source, the active resonating element feeding the parasitic resonating element.

Another example method of any preceding method includes receiving an incoming radio frequency signal at the active resonating element via the parasitic resonating element.

Another example method of any preceding method includes tuning the impedance of the active resonating element with at least one inductor.

Another example method of any preceding method includes tuning the impedance of the active resonating element with at least one capacitor.

Another example method of any preceding method includes the plurality of resonating loop antennas comprises two loop antennas.

Another example method of any preceding method includes the active resonating element is electrically connected to ground.

An example antenna includes a computing device case, a radiofrequency signal source disposed inside the computing device case, a dielectric substrate disposed above a ground plane inside the computing device case, an active resonating element routed across the surface of the dielectric substrate and driven by the radiofrequency signal source, the active resonating element forming a plurality of inductively-coupled resonating loop antennas, the active resonating element further electrically connected to the ground plane. A a parasitic resonating element is capacitively driven by the inductively-coupled resonating loop antennas. A radio transceiver is communicatively coupled to the active resonating element, the radio transceiver being configured to send and receive radio transmissions via the parasitic resonating element.

Another example device of any preceeding device includes the active resonating element is arranged on the opposite side of the dielectric substrate from the parasitic resonating element.

Another example device of any preceeding device includes the parasitic resonating element is not disposed on the substrate.

Another example device of any preceeding device includes forming a second parasitic resonating element on the substrate, the second parasitic resonating element being electrically separate from the parasitic resonating element and electrically separate from the active resonating element.

Another example device of any preceeding device includes the plurality of resonating loop antennas are dimensioned to provide a substantially flat efficiency matching response by the parasitic resonating element over a frequency band ranging from approximately 2.0 GHz to 2.8 GHz.

Another example device of any preceeding device includes the plurality of loop antennas are two loop antennas.

Another example device of any preceeding device includes the parasitic resonating element is an LTE antenna.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

Although the present examples may be described and illustrated herein as implemented on a smartphone or a mobile phone, the present examples are suitable for application in a variety of different computing devices including hand-held devices, phones, tablets, desktop computers, and other electronic devices.

What is claimed is:

1. A device comprising:
a radiofrequency signal source;
a dielectric substrate;
an active resonating element routed across the surface of the dielectric substrate and driven by the radiofrequency signal source, the active resonating element forming a plurality of inductively-coupled loop antennas;
a parasitic resonating element capacitively driven by the inductively-coupled loop antennas.

2. The device of claim 1, wherein the parasitic resonating element is a chip antenna.

3. The device of claim 1, wherein the parasitic resonating element includes a variable capacitor.

4. The device of claim 1, wherein the parasitic resonating element is an LTE antenna.

5. The device of claim 1, wherein the active resonating element forms two loop antennas.

6. The device of claim 1, wherein the active resonating element and the parasitic resonating element are arranged on opposite sides of the substrate.

7. The device of claim 1, wherein the active resonating element includes at least one capacitor and at least one inductor.

8. A method comprising:
providing a radiofrequency signal source, a dielectric substrate, a parasitic resonating element, and an active resonating element, the active resonating element forming a plurality of inductively-coupled resonating loop antennas;
driving the active resonating element by the radiofrequency signal source, the active resonating element feeding the parasitic resonating element.

9. The method of claim 8, further comprising receiving an incoming radio frequency signal at the active resonating element via the parasitic resonating element.

10. The method of claim 8, further comprising tuning the impedance of the active resonating element with at least one inductor.

11. The method of claim 8, further comprising tuning the impedance of the active resonating element with at least one capacitor.

12. The method of claim 8, wherein the plurality of resonating loop antennas comprises two loop antennas.

13. The method of claim 8, wherein the active resonating element is electrically connected to ground.

14. An antenna-based device comprising:
a computing device case;
a radiofrequency signal source disposed inside the computing device case;
a dielectric substrate disposed inside the computing device case;
an active resonating element routed across the surface of the dielectric substrate and driven by the radiofrequency signal source, the active resonating element forming a plurality of inductively-coupled resonating loop antennas, the active resonating element further electrically connected to the ground plane;
a parasitic resonating element capacitively driven by the inductively-coupled resonating loop antennas;
a radio transceiver communicatively coupled to the active resonating element, the radio transceiver configured to send and receive radio transmissions via the parasitic resonating element.

15. The antenna-based device of claim 14, wherein the active resonating element is arranged on the opposite side of the dielectric substrate from the parasitic resonating element.

16. The antenna-based device of claim 14, wherein the parasitic resonating element is not disposed on the substrate.

17. The antenna-based device of claim 14, further comprising forming a second parasitic resonating element on the substrate, the second parasitic resonating element being electrically separate from the parasitic resonating element and electrically separate from the active resonating element.

18. The antenna-based device of claim 14, wherein the plurality of resonating loop antennas are dimensioned to provide a substantially flat efficiency matching response by the parasitic resonating element over a frequency band ranging from approximately 2.0 GHz to 2.9 GHz.

19. The antenna-based device of claim 15, wherein the plurality of loop antennas comprises two loop antennas.

20. The antenna-based device of claim 15, wherein the parasitic resonating element is an LTE antenna.
